(19) United States
(12) Patent Application Publication
(10) Pub. No.: US 2018/0046105 A1
(43) Pub. Date: Feb. 15, 2018

(54) CURABLE LIQUID DEVELOPER

(71) Applicant: CANON KABUSHIKI KAISHA, Tokyo (JP)

(72) Inventors: Hiroshi Tanabe, Yokohama-shi (JP); Junji Ito, Hiratsuka-shi (JP); Yasuhiro Aichi, Tokyo (JP); Jun Shirakawa, Kawaguchi-shi (JP)

(21) Appl. No.: 15/549,484

(22) PCT Filed: Apr. 20, 2016
(86) PCT No.: PCT/JP2016/063118

§ 371 Date: Aug. 8, 2017

(30) Foreign Application Priority Data
Apr. 24, 2015 (JP) 2015-089515
Apr. 13, 2016 (JP) 2016-080502

(51) Int. Cl. G03G 9/125; C08F 36/04; C08F 290/04; G03G 9/13

(52) U.S. Cl. CPC G03G 9/125; G03G 9/131; C08F 36/04; C08F 290/048; C08F 2500/01

(57) ABSTRACT

Provided is a curable liquid developer having sufficient fixability while being a curable liquid developer containing a polymer material. The curable liquid developer includes: a cationic polymerizable liquid monomer including a vinyl ether monomer; and toner particles insoluble in the cationic polymerizable liquid monomer, in which the curable liquid developer further includes a polymerizable polyolefin including a polyolefin in a main chain thereof, the polymerizable polyolefin having a vinyl ether group at at least one terminal of the polyolefin.

### TECHNICAL FIELD

The present invention relates to a curable liquid developer to be used in an electrophotographic image forming apparatus utilizing an electrophotographic system, such as an electrophotographic method, an electrostatic recording method, or electrostatic recording printing.

### BACKGROUND ART

An electrophotographic system is a method of obtaining a printed product involving: uniformly charging a surface of an image bearing member, such as a photosensitive member (charging step); exposing the surface of the image bearing member to light to form an electrostatic latent image thereon (exposing step); developing the formed electrostatic latent image with a developer containing toner particles (coloring resin particles) to form a toner image (developer image) (developing step); transferring the toner image onto a recording medium, such as paper or a plastic film (transferring step); and fixing the transferred toner image to the recording medium (fixing step).

The developers are roughly classified into: a dry developer in which toner particles each including materials including a colorant, such as a pigment, and a binder resin are used in dry states; and a liquid developer in which the toner particles are used after having been dispersed in a liquid, such as an electrically insulating liquid.

In recent years, there have been growing needs for color printing and high-speed printing in electrophotographic image forming apparatus, such as a copying machine, a facsimile, and a printer each utilizing the electrophotographic system. In the color printing, a high-resolution and high-quality image is required, and hence a developer that can form a high-resolution and high-quality color image, and is applicable to the high-speed printing has been required.

The liquid developer has been known as a developer that is advantageous in terms of the reproducibility of a color image. In the liquid developer, fine toner particles can be used because the aggregation of the toner particles in the liquid developer during its storage hardly occurs. Accordingly, the liquid developer easily provides excellent characteristics in terms of the reproducibility of a thin-line image and gradation reproducibility. The following digital printing apparatus has started to be vigorously developed through a good use of those excellent advantages. The apparatus can print a high-quality image at a high speed through the utilization of an electrophotographic technology involving using the liquid developer. Under such circumstances, the development of a liquid developer having additionally satisfactory characteristics has been required.

A developer obtained by dispersing toner particles in an electrically insulating liquid, such as a hydrocarbon organic solvent or a silicone oil, has heretofore been known as the liquid developer.

However, when the electrically insulating liquid remains on a recording medium, such as paper or a plastic film, a remarkable reduction in image quality may occur, and hence the electrically insulating liquid needs to be removed.

A general method for the removal of the electrically insulating liquid involves applying thermal energy to volatilize and remove the electrically insulating liquid.

However, the method is not necessarily preferred from the viewpoints of the environment and energy saving because an organic solvent vapor may be emitted to the outside of the apparatus or a great deal of energy is required at the time of the removal.

A method involving curing the electrically insulating liquid through photopolymerization has been proposed as a countermeasure against the foregoing. A developer obtained as described below is used as a photocurable liquid developer. A monomer having a reactive functional group is used as the electrically insulating liquid, and a photopolymerization initiator is dissolved therein. The photocurable liquid developer is cured by subjecting the reactive functional group to a reaction through irradiation with light, such as UV light, and is applicable to the high-speed printing. Such photocurable liquid developer has been proposed in PTL 1.

In PTL 1, acrylate monomers, such as urethane acrylate, are given as examples of the monomer having the reactive functional group.

However, each of the acrylate monomers has a low volume resistance and is hence liable to reduce the potential of an electrostatic latent image in the developing step. Accordingly, a high image density is hardly obtained or image blurring (phenomenon in which an image poor in sharpness is obtained) occurs in some cases.

In addition, in PTL 2, there is a proposal that a curable liquid vehicle having a specific resistance value range be used as a curable electrically insulating liquid, and cationic polymerizable monomers, such as an epoxy compound, vinyl ether, and a cyclic vinyl ether, are given as examples of the curable liquid vehicle. Of those, a vinyl ether monomer is suitable as a curable electrically insulating liquid vehicle because the monomer easily provides a high volume resistivity and has a fast reaction rate. Further, in PTL 2, there is a proposal that a curable liquid vehicle having a specific viscosity range be used, and the viscosity of a liquid developer is adjusted for modifying its mechanical properties, such as adhesiveness with a recording medium (substrate) and aggregability. Polymer materials, such as an alkylated polyvinylpyrrolidone, a polyisobutylene, a block copolymer of a polystyrene-b-hydrogenated butadiene, and a glycol rosin ester, are given as examples of a viscosity adjustor.

### CITATION LIST

### Patent Literature

PTL 1: Japanese Patent Application Laid-Open No. 2003-57883

PTL 2: Japanese Patent No. 3442406

### SUMMARY OF INVENTION

### Technical Problem

When a cationic polymerizable liquid monomer serving as one kind of the electrically insulating liquids polymerizes, the monomer is liable to undergo curing inhibition due to moisture. Even when any such polymer material as described in PTL 2 is added as the viscosity adjustor, the material species of the additive is limited. For example, when the polymer material contains a large amount of a heteroatom, such as oxygen or nitrogen, the material is liable to adsorb moisture in the air through such molecule, and hence the monomer is liable to undergo the curing inhibition. Meanwhile, when a material mainly formed of a hydrocarbon is used as the polymer material, the adsorption of the moisture to the inside of the polymer material is suppressed, but the polymer material itself may inhibit the polymerization of the cationic polymerizable liquid monomer, and hence there occurs, for example, a problem in that a liquid developer does not fix, or even when the developer fixes, tackiness remains on the surface of its cured film after the fixation. Accordingly, there occurs a problem in that the fixability of the liquid developer reduces in association with the expression of the viscosity of the liquid developer.

That is, an object of the present invention is to provide a curable liquid developer having sufficient fixability while being a curable liquid developer containing a polymer material.

### Solution to Problem

The present invention relates to a curable liquid developer, including:

a cationic polymerizable liquid monomer including a vinyl ether monomer; and

toner particles insoluble in the cationic polymerizable liquid monomer,

in which the curable liquid developer further includes a polymerizable polyolefin including a polyolefin in a main chain thereof, the polymerizable polyolefin having a vinyl ether group at at least one terminal of the polyolefin.

### Advantageous Effects of Invention

According to the present invention, the curable liquid developer having sufficient fixability while being a curable liquid developer containing a polymer material can be provided.

Further features of the present invention will become apparent from the following description of exemplary embodiments with reference to the attached drawings.

### BRIEF DESCRIPTION OF DRAWINGS

FIG. 1 is a ¹H-NMR spectrum chart of Exemplified Compound A-13 synthesized in Synthesis Example 1.

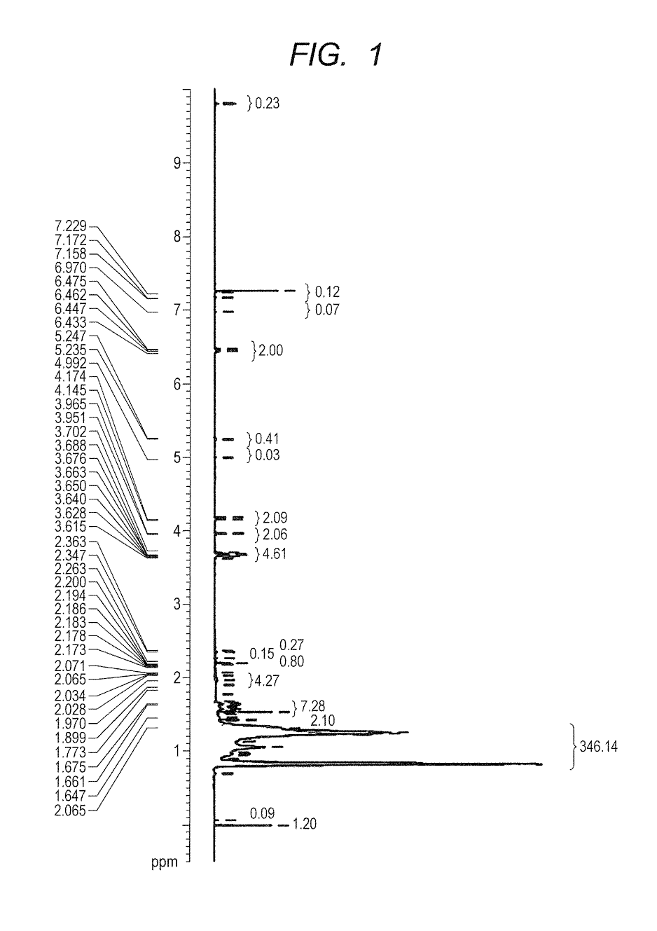

FIG. 2A is an enlarged view of the ¹H-NMR spectrum chart of Exemplified Compound A-13 shown in FIG. 1 in the range of from 0.6 ppm to 2.4 ppm.

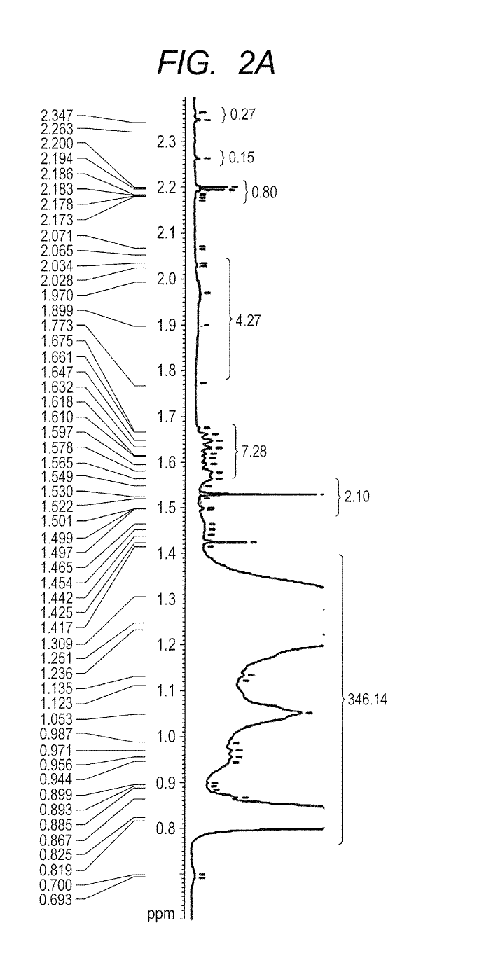

FIG. 2B is an enlarged view of the ¹H-NMR spectrum chart of Exemplified Compound A-13 shown in FIG. 1 in the range of from 3.5 ppm to 5.5 ppm.

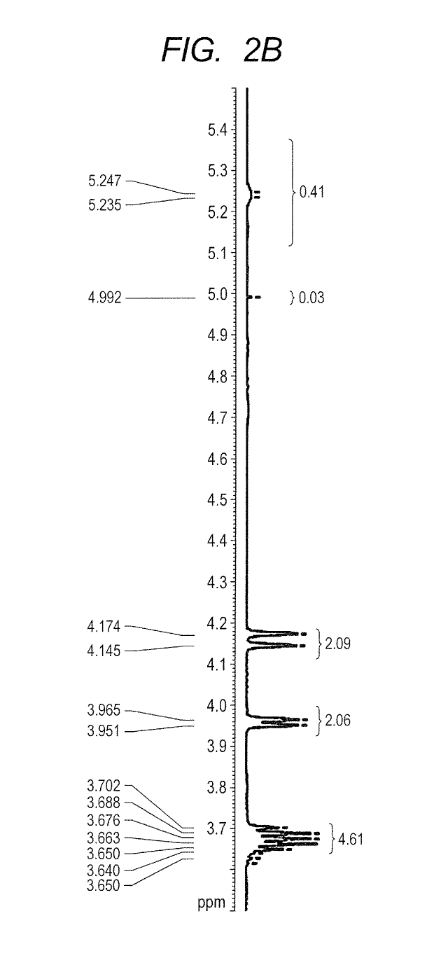

FIG. 2C is an enlarged view of the ¹H-NMR spectrum chart of Exemplified Compound A-13 shown in FIG. 1 in the range of from 6.9 ppm to 10.0 ppm.

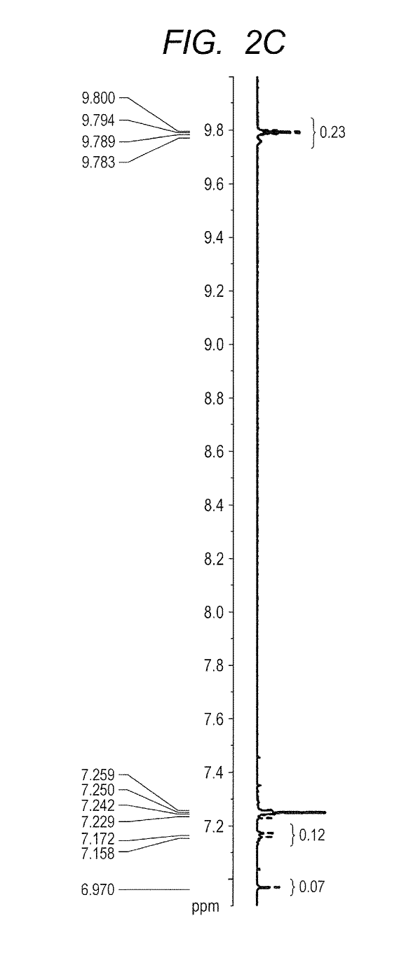

FIG. 3 is an IR spectrum chart of Exemplified Compound A-13 synthesized in Synthesis Example 1.

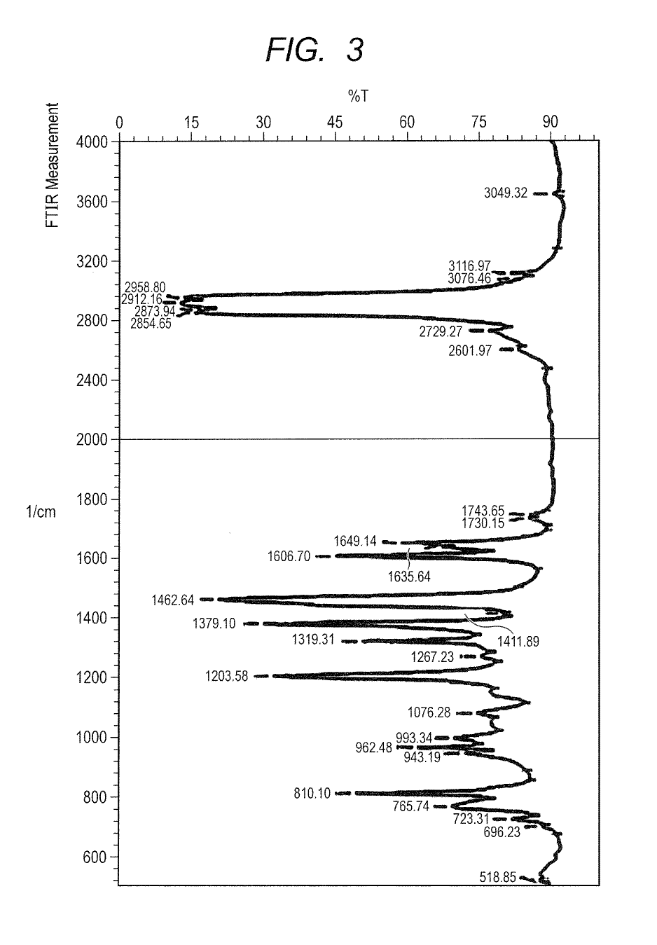

FIG. 4 is a ¹H-NMR spectrum chart of Exemplified Compound A-12 synthesized in Synthesis Example 3.

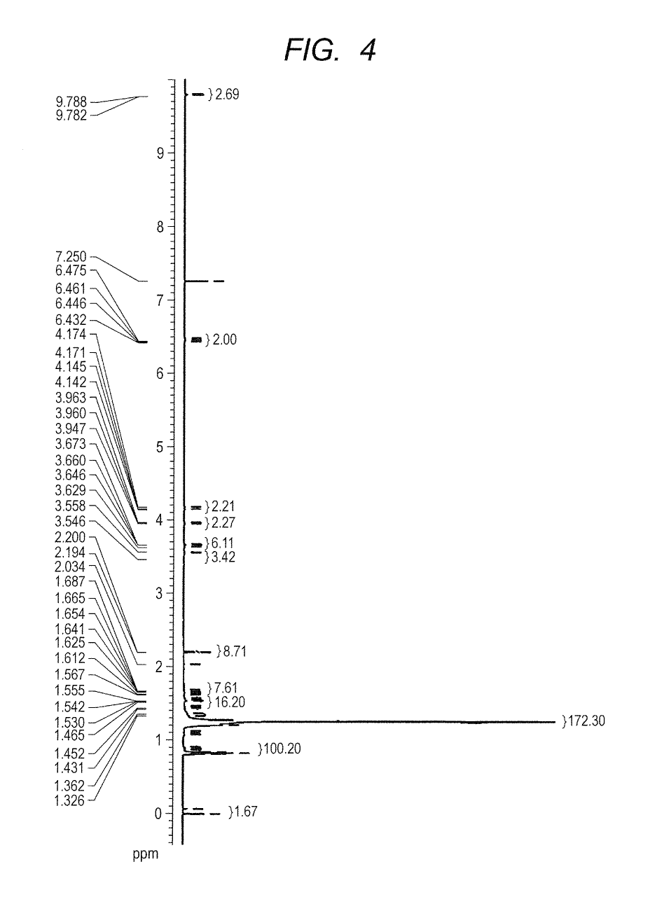

FIG. 5A is an enlarged view of the ¹H-NMR spectrum chart of Exemplified Compound A-12 shown in FIG. 4 in the range of from 0.6 ppm to 2.3 ppm.

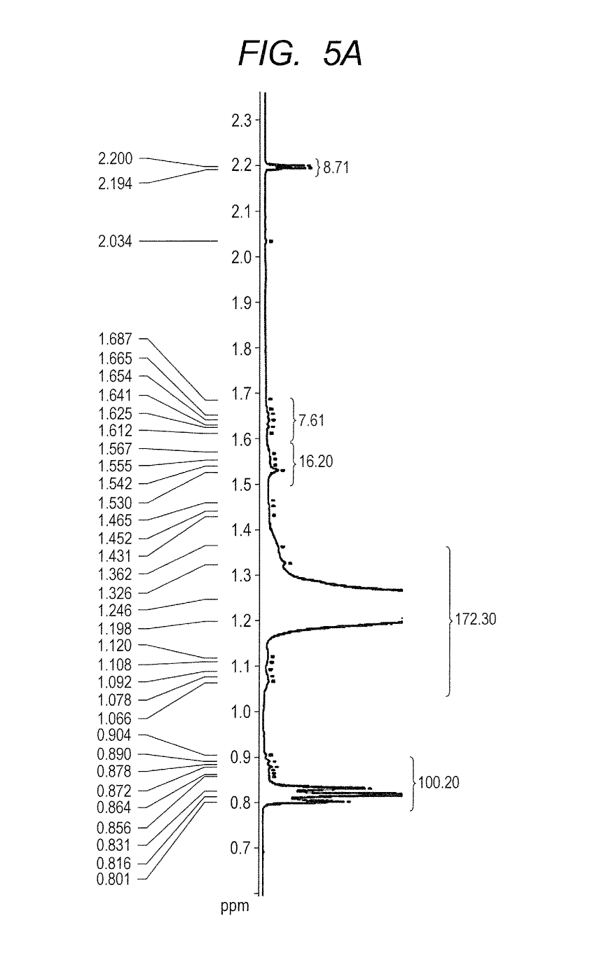

FIG. 5B is an enlarged view of the ¹H-NMR spectrum chart of Exemplified Compound A-12 shown in FIG. 4 in the range of from 3.0 ppm to 4.5 ppm.

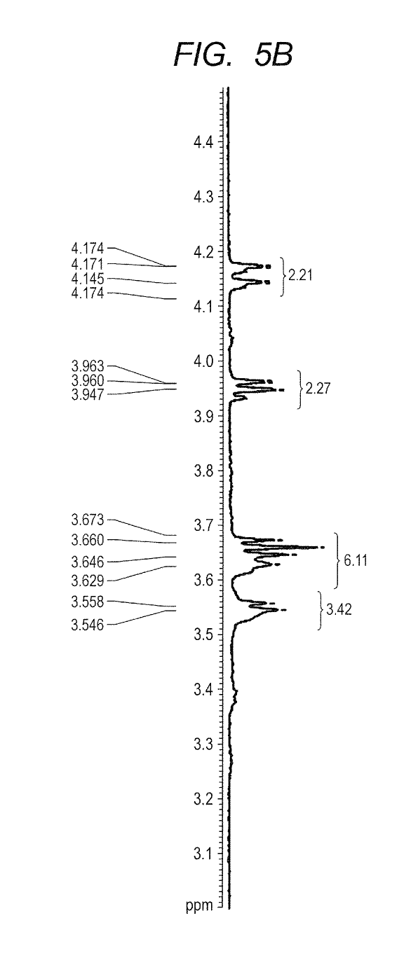

FIG. 5C is an enlarged view of the ¹H-NMR spectrum chart of Exemplified Compound A-12 shown in FIG. 4 in the range of from 6.0 ppm to 10.0 ppm.

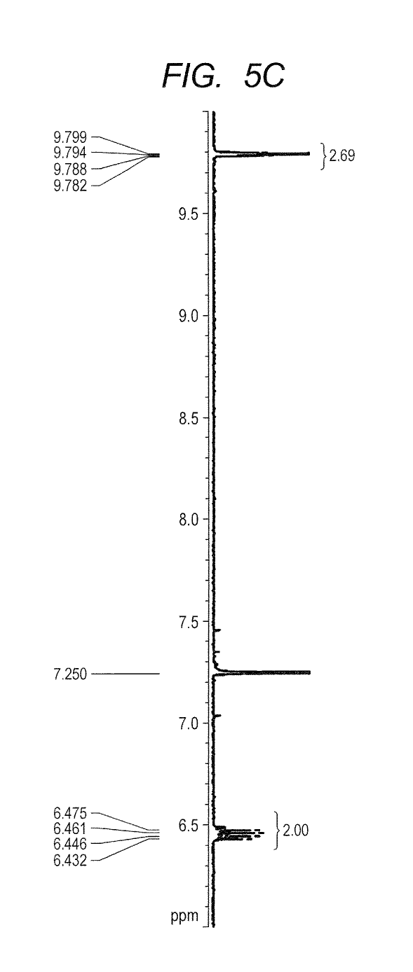

FIG. 6 is an IR spectrum chart of Exemplified Compound A-12 synthesized in Synthesis Example 3.

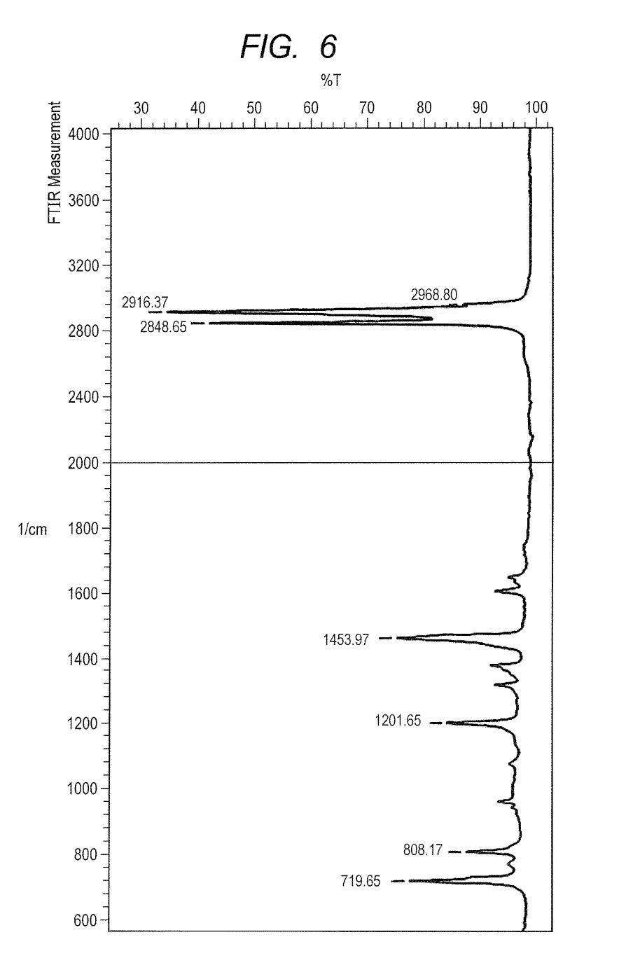

### DESCRIPTION OF EMBODIMENTS

Preferred embodiments of the present invention will now be described in detail in accordance with the accompanying drawings.

A curable liquid developer of the present invention includes:

a cationic polymerizable liquid monomer including a vinyl ether monomer; and

toner particles insoluble in the cationic polymerizable liquid monomer,

in which the curable liquid developer further includes a polymerizable polyolefin including a polyolefin in a main chain thereof, the polymerizable polyolefin having a vinyl ether group at at least one terminal of the polyolefin.

In addition, a curable liquid of the present invention includes a polymerizable polyolefin including a polyolefin in a main chain thereof, the polymerizable polyolefin having a vinyl ether group at at least one terminal of the polyolefin.

A fixing system based on UV light, a fixing system based on an electron beam (EB), or the like has been known as a fixing system.

The respective constituent components to be incorporated into the curable liquid developer of the present invention are described below.

[Polymerizable Polyolefin]

A polymerizable polyolefin of the present invention is a polymerizable compound.

The polymerizable polyolefin of the present invention has a feature of including a polyolefin, such as polymer derived from propylene, butadiene, or isoprene, in a main chain thereof and having a vinyl ether group at a terminal of the polyolefin. The polymerizable polyolefin of the present invention is a cationic polymerizable compound having the vinyl ether group, and can provide a curable liquid developer having a high electric resistance and high sensitivity.

The polymerizable polyolefin in the curable liquid developer of the present invention is preferably a compound free of any heteroatom in a portion except the vinyl ether group (CH₂═CH—O—). The term “heteroatom” as used herein refers to an atom except a carbon atom and a hydrogen atom. When the polymerizable polyolefin is free of any heteroatom in the portion except the vinyl ether group, the uneven distribution of an electron density in a molecule thereof is suppressed, and hence a high electric resistance is easily obtained.

Further, the polymerizable polyolefin in the curable liquid developer of the present invention is preferably a polymerizable polyolefin free of any carbon-carbon double bond in the portion except the vinyl ether group (CH₂═CH—O—). When the polymerizable polyolefin is free of any carbon-carbon double bond in the portion except the vinyl ether group, the uneven distribution of the electron density is suppressed and hence a high electric resistance is easily obtained.

Specific examples [Exemplified Compounds A-1 to A-18] of the polymerizable polyolefin that can be used in the present invention are given below, but the present invention is not limited to these examples (i, m, and n each represent an arbitrary integer).

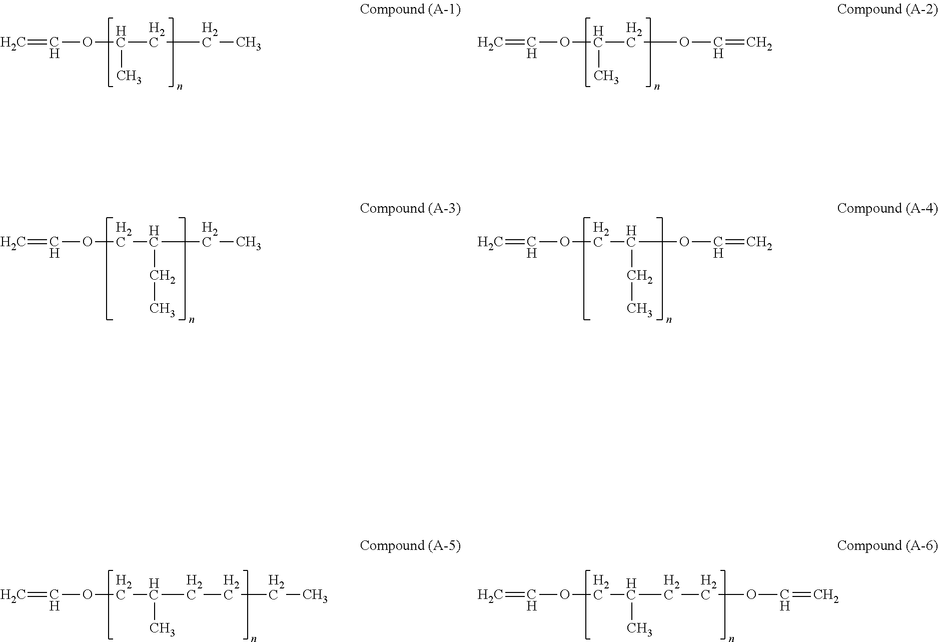

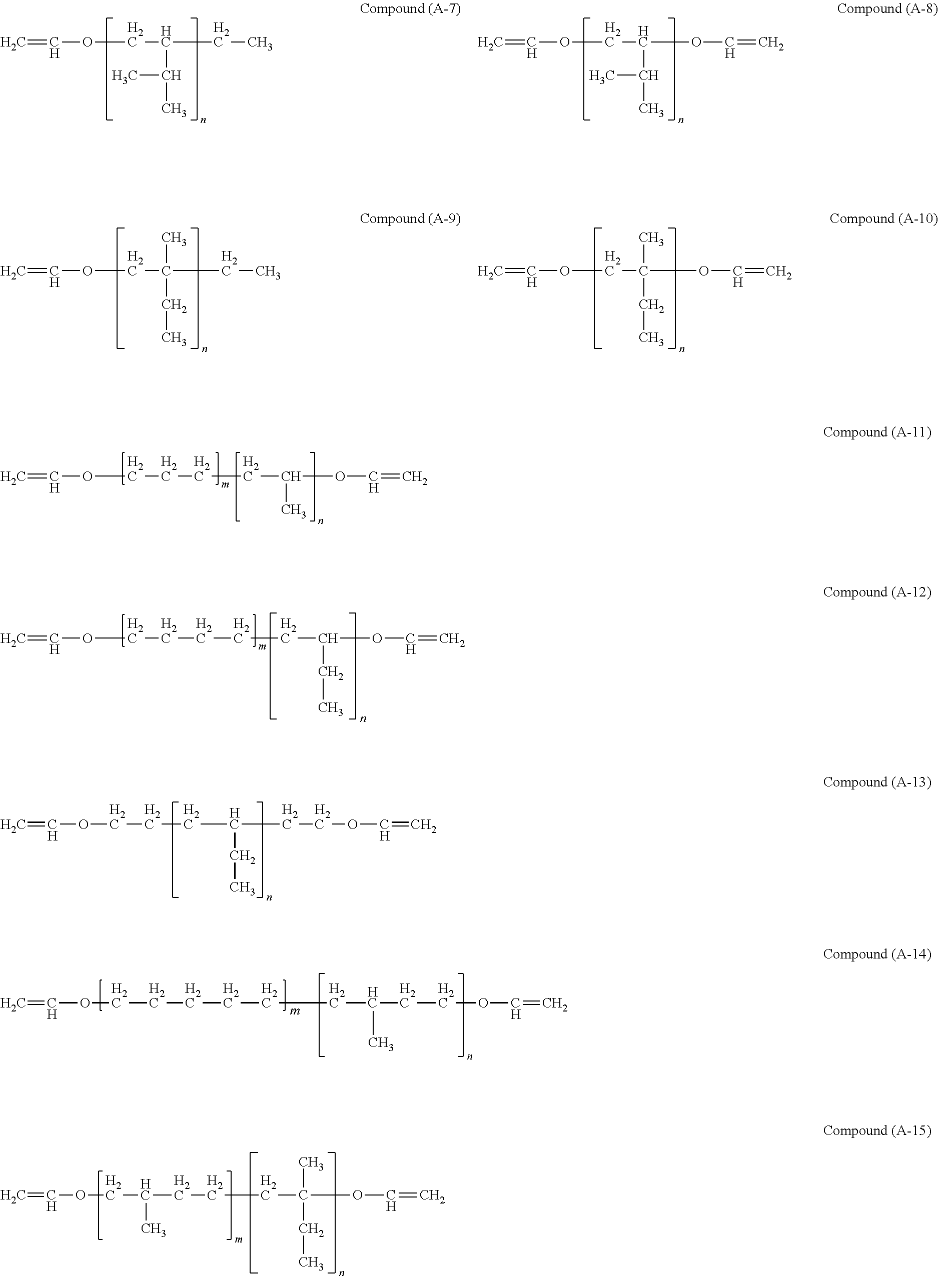

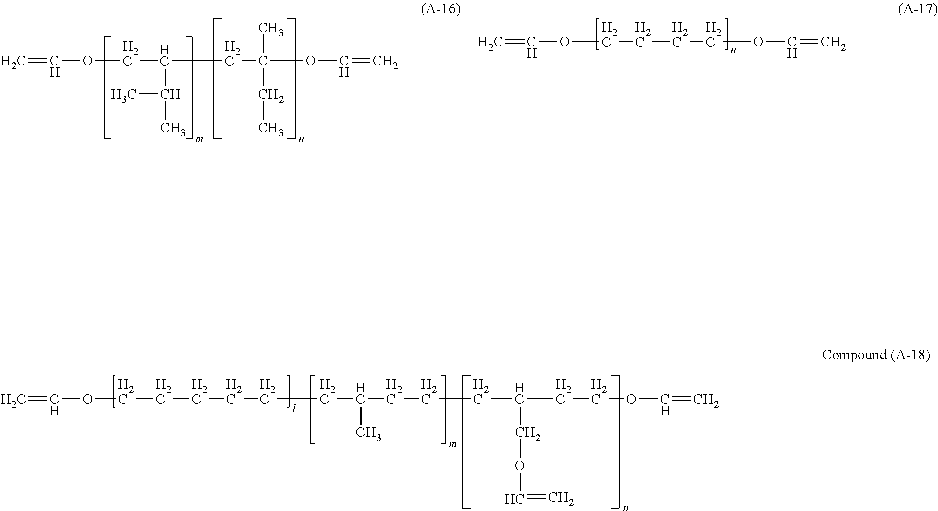

(In the formulae, l, m, and n each independently represent an integer of 0 or more, provided that the case where all of l, m, and n represent 0 is excluded.)

The polymerizable polyolefin of the present invention has the vinyl ether group at a terminal of the polyolefin serving as the main chain. Accordingly, even when the polymerizable polyolefin is used after having been added to the cationic polymerizable liquid monomer including the vinyl ether monomer, the polymerizable polyolefin can crosslink together with the cationic polymerizable liquid monomer to cure, and hence does not inhibit the curing of the cationic polymerizable liquid monomer.

Of the exemplified compounds, a compound having vinyl ether groups at a plurality of terminals of the polyolefin serving as the main chain is preferred because the compound is advantageous in terms of the fixability of the developer. A vinyl ether group may be added to a side chain branched from the polyolefin main chain like Exemplified Compound (A-18).

In addition, when the polymerizable polyolefin of the present invention is used in a cationic polymerizable curable liquid developer, the polymerizable polyolefin is preferably made hard to undergo curing inhibition due to moisture. Accordingly, its solubility parameter (hereinafter abbreviated as “SP value”) is preferably set to a low value. The SP value is one of the affinity parameters. It is hypothesized that a force acting between two components in a regular solution, i.e., a solution free of an action, such as an electrostatic interaction, association (hydrogen bond), or a dipole interaction, is an intermolecular force alone, and hence the solubility parameter is used as a measure representing the intermolecular force. An actual solution is not necessarily a regular solution, but it has been empirically known that as a difference in SP value between the two components becomes smaller, the solubility of one of the components in the other increases. The SP value of water is 23.4 (cal/cm³)^{1/2}, which is a value larger than those of other solvents, and hence setting the SP value of the polymerizable polyolefin having the vinyl ether group to as small a value as possible can suppress the curing inhibition due to the dissolution of the moisture. Specifically, the SP value of the polymerizable polyolefin of the present invention preferably falls within the range of from 7.5 (cal/cm³)^{1/2} or more to 9.0 (cal/cm³)^{1/2} or less. Hansen's or Hoy's calculation method in which the SP value is estimated from a molecular structure has been known as a method of calculating the SP value, but in the present invention, the SP value was calculated by using Fedors' estimation method by which the SP value was able to be determined in a relatively simple manner.

When the polyolefin constituting the polymerizable polyolefin of the present invention is considered based on the viewpoint of such SP value, increasing the number of branches of an alkyl chain constituting the polyolefin is effective in reducing the SP value. A polyolefin having a structure derived from 1,2-polybutadiene or 1,4-polyisoprene that is relatively easily available is more preferably used as such polyolefin having a large number of branches of its alkyl chain.

The polymerizable polyolefin of the present invention is obtained by the following method. At first, a terminal of such polyolefin is hydroxylated. If a double bond moiety remains in the polyolefin serving as the main chain, the double bond moiety was turned into a single bond by hydrogenation. Then, the hydroxy group is turned into a vinyl ether group.

A method involving using an acetylene gas as described in International Publication No. WO2013/018302 has been known as a synthesis method involving producing a vinyl ether group from a hydroxy group. A method involving using vinyl acetate and an iridium complex as described in J. AM. Chem. SOC. 9, Vol. 124, No. 8, 2002, 1590-1591 has also been known.

A commercial product can also be utilized as the hydrogenated polyolefin having a hydroxy group at a terminal thereof. For example, POLYTAIL H (manufactured by Mitsubishi Chemical Corporation), and GI-1000, GI-2000, and GI-3000 (each manufactured by Nippon Soda Co., Ltd.) are each available as a hydrogenated polybutadiene having hydroxy groups at both of its terminals, and EPOL (manufactured by Idemitsu Kosan Co., Ltd.) is available as a hydrogenated polyisoprene having hydroxy groups at both of its terminals.

The weight-average molecular weight of the polymerizable polyolefin of the present invention is preferably 900 or more 10,000 or less, and more preferably 1,000 or more 10,000 or less in consideration of the developability of the curable liquid developer and its compatibility with the cationic polymerizable liquid monomer.

Meanwhile, the weight-average molecular weight of the polymerizable polyolefin of the present invention is preferably 900 or more, more preferably 1,000 or more in order that the developer may show sufficient fixability.

When the weight-average molecular weight of the polymerizable polyolefin is 10,000 or less, the concentration of the curable liquid developer hardly rises excessively and the movement of the toner particles hardly deteriorates, and hence the developability hardly reduces. When the compatibility with the cationic polymerizable liquid monomer is satisfactory, the uniformity of a film of the developer after its fixation is easily maintained and hence irregularities hardly appear on the surface of a film.

Meanwhile, with regard to the fixability, the weight-average molecular weight of the polymerizable polyolefin is preferably as large as possible. That is, as the weight-average molecular weight of the polymerizable polyolefin increases, the fixability of the curable liquid developer tends to be improved. This is probably because of the following reason: when a thin film of the curable liquid developer that is uncured is formed on a recording medium, such as paper, moisture in the recording medium is liable to migrate to the inside of the curable liquid developer to cause curing inhibition, but the addition of the polymerizable polyolefin having a relatively high molecular weight and a viscosity enables the fixation of the curable liquid developer under a state in which the migration of the moisture from the recording medium to the curable liquid developer is suppressed.

One kind of such compounds as described above may be used as the polymerizable polyolefin of the present invention, or a mixture of two or more kinds thereof may be used, and mixing the polymerizable polyolefin with the cationic polymerizable liquid monomer can adjust the viscosity of the curable liquid developer.

[Cationic Polymerizable Liquid Monomer]

The curable liquid developer of the present invention contains the cationic polymerizable liquid monomer.

For example, an acrylic monomer or a cyclic ether monomer, such as an epoxy or oxetane, can be utilized as the cationic polymerizable liquid monomer. When a vinyl ether compound out of those monomers is used, a curable liquid developer having a high electric resistance, a low viscosity, and high sensitivity can be obtained. In the present invention, the vinyl ether compound (vinyl ether monomer) is used. The ratio of the vinyl ether monomer in the total amount of the cationic polymerizable liquid monomer is preferably 75% by mass or more, further preferably 100% by mass.

The term “vinyl ether monomer” as used herein refers to a compound obtained by adding a vinyl ether group to a terminal of a monomer free of a repeating unit except a methylene group in its main chain. The molecular weight of the vinyl ether monomer is preferably less than 300.

Specific examples [Exemplified Compounds C-1 to C-28] of the vinyl ether monomer are given below, but the present invention is not limited to these examples.

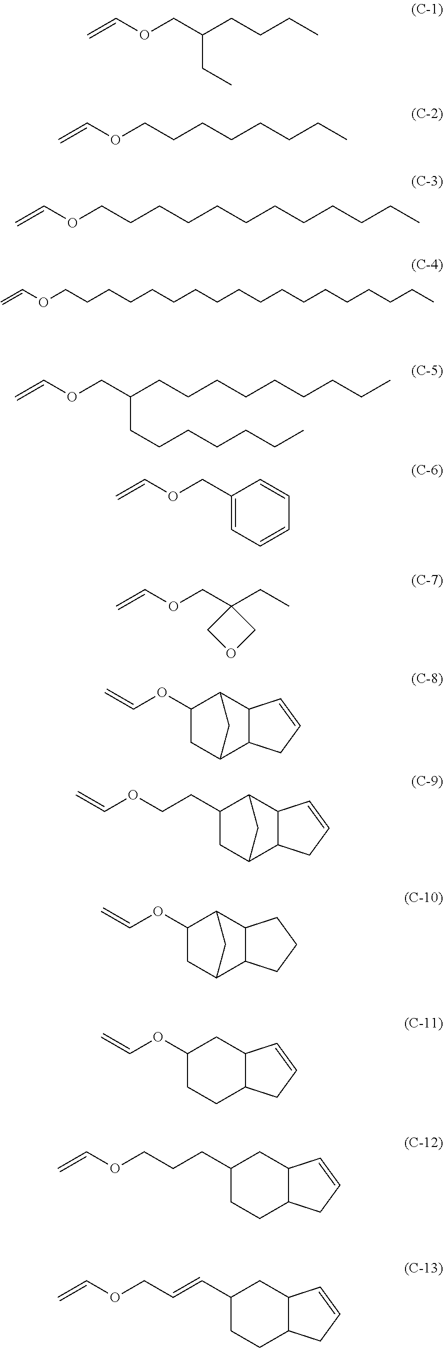

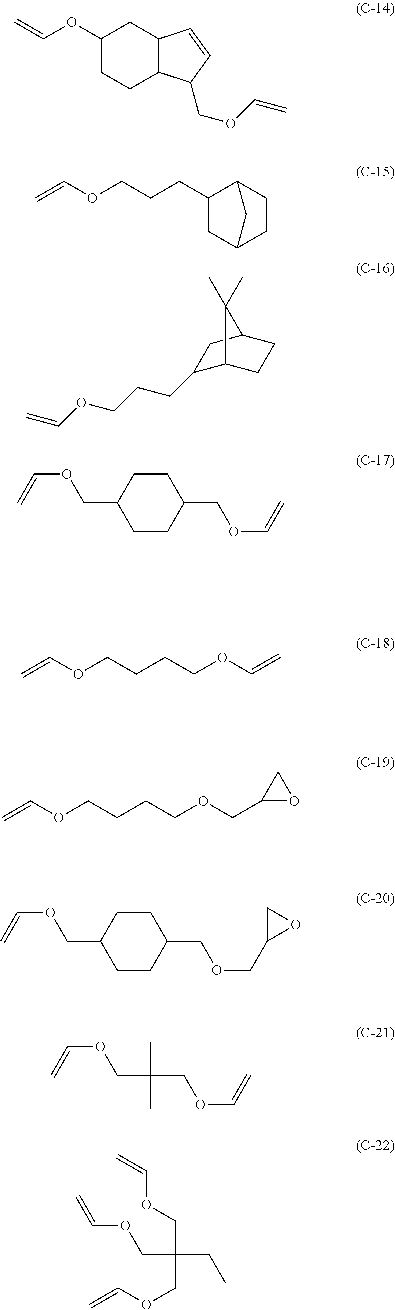

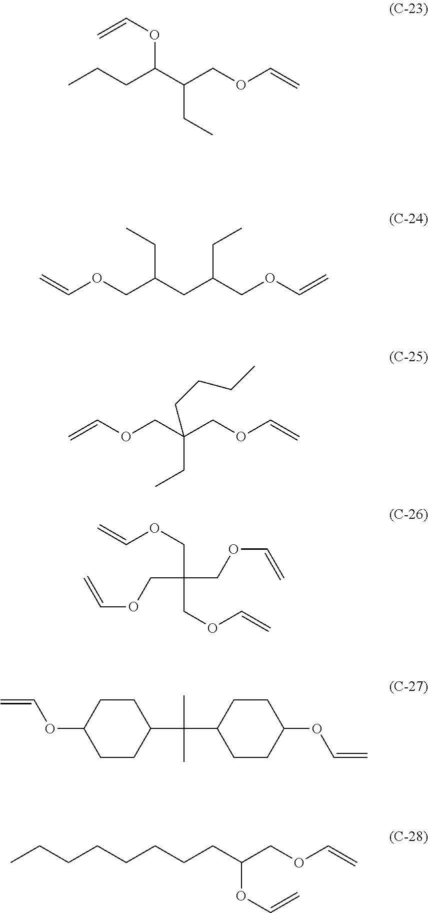

As in the polymerizable polyolefin, the vinyl ether monomer is preferably free of any heteroatom in a portion except the vinyl ether group (CH₂═CH—O—). Further, the vinyl ether monomer is preferably free of any carbon-carbon double bond in the portion except the vinyl ether group (CH₂═CH—O—). When the vinyl ether monomer is free of any carbon-carbon double bond in the portion except the vinyl ether group, the uneven distribution of an electron density in a molecule thereof is suppressed, and hence a high electric resistance is easily obtained. Preferred examples thereof include 5,6-dihydrodicyclopentadiene vinyl ether (C-8), tricyclo[5.2.1.0^{2,6}]decane vinyl ether (C-10), cyclohexanedimethanol divinyl ether (C-17), neopentyl glycol divinyl ether (C-21), trimethylolpropane trivinyl ether (C-22), 2-ethyl-1,3-hexanediol divinyl ether (C-23), 2,4-diethyl-1,5-pentanediol divinyl ether (C-26), 2-butyl-2-ethyl-1,3-propanediol divinyl ether (C-27), pentaerythritol tetravinyl ether (C-26), and 1,2-decanediol divinyl ether (C-28).

In the present invention, the polymerizable polyolefin is dissolved in such vinyl ether monomer, and hence compatibility between the vinyl ether monomer and the polymerizable polyolefin is preferably considered. As a difference in SP value between both the materials enlarges, the compatibility between the vinyl ether monomer and the polymerizable polyolefin deteriorates, and hence the molecules of the polymerizable polyolefin are liable to aggregate in the curable liquid developer of the present invention to form an aggregate and precipitate. When the aggregate is formed, the uniformity of a film of the developer deteriorates, and the deterioration is responsible for the appearance of irregularities on the surface of the cured film or for the opacification of the film. Accordingly, the compatibility between the vinyl ether monomer and the polymerizable polyolefin is preferably secured. That is, the difference in SP value between both the materials needs to be reduced, and the difference in SP value between both the materials is preferably 1.0 (cal/cm³)^{1/2} or less. Further, in consideration of the fact that the vinyl ether monomer needs to be made hardly influenced by moisture, the SP value of the vinyl ether monomer is preferably 7.5 (cal/cm³)^{1/2} or more and 9.0 (cal/cm³)^{1/2} or less.

[Toner Particles]

The curable liquid developer of the present invention contains the toner particles insoluble in the cationic polymerizable liquid monomer including the vinyl ether monomer. When the toner particles are insoluble in the vinyl ether monomer, the toner particles may be substantially insoluble in the polymerizable polyolefin having vinyl ether groups of the present invention as well. The toner particles each generally contain a binder resin and a pigment. A charge director may be incorporated into each of the toner particles as required.

A method of producing the toner particles is, for example, a method such as a coacervation method or a wet pulverization method.

Details about the coacervation method are described in international publications (WO02007/000974A and WO02007/000975A). In addition, details about the wet pulverization method are described in international publications (WO02006/126566A and WO02007/108485A). Any such method can be utilized in the present invention.

The number-average particle diameter of the toner particles obtained by any such method is preferably 0.05 μm or more and 5 μm or less, more preferably 0.05 μm or more and 1 μm or less from the viewpoint that a high-definition image is obtained.

Binder Resin

A binder resin having fixability to an adherend (recording medium), such as paper or a plastic film, can be used as the binder resin to be incorporated into each of the toner particles. Examples of the binder resin include resins such as an epoxy resin, an ester resin, an acrylic resin, a styrene-acrylic resin, an alkyd resin, a polyethylene resin, an ethylene-acrylic resin, and a rosin-modified resin. As required, one kind of those resins can be used alone, or two or more kinds thereof can be used in combination. The content of the binder resin is preferably 50 parts by mass or more and 1,000 parts by mass or less with respect to 100 parts by mass of the pigment.

Pigment

Commercially available organic pigments and inorganic pigments, a product obtained by dispersing a pigment in an insoluble resin or the like serving as a dispersion medium, a product obtained by grafting a resin to the surface of a pigment, and the like can each be used as the pigment to be incorporated into each of the toner particles.

The pigment is, for example, a pigment described in W. Herbst, K. Hunger “Industrial Organic Pigments.”

Specific examples of the organic pigment and the inorganic pigment include the following pigments. As a yellow coloring pigment, there are given, for example: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, or 185; and C.I. Vat Yellow 1, 3, or 20.

As a red or magenta coloring pigment, there are given, for example: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, or 269; C.I. Pigment Violet 19; and C.I. Vat Red 1, 2, 10, 13, 15, 23, 29, or 35.

As a blue or cyan coloring pigment, there are given, for example: C.I. Pigment Blue 2, 3, 15:2, 15:3, 15:4, 16, or 17; C.I. Vat Blue 6; C.I. Acid Blue 45; and a copper phthalocyanine pigment in which a phthalocyanine skeleton is substituted by 1 to 5 phthalimidomethyl groups.

As a green coloring pigment, there is given, for example, C.I. Pigment Green 7, 8, or 36.

As an orange coloring pigment, there is given, for example, C.I. Pigment Orange 66 or 51.

As a black coloring pigment, there are given, for example, carbon black, titanium black, and aniline black.

A white pigment is specifically exemplified by basic lead carbonate, zinc oxide, titanium oxide, and strontium titanate.

Here, titanium oxide has a small specific gravity, has a large refractive index, and is chemically and physically stable as compared to any other white pigment. Accordingly, titanium oxide has a large hiding power and a large coloring power as a pigment, and is excellent in durability against an acid, an alkali, and other environments. Therefore, titanium oxide is preferably utilized as the white pigment. Other white pigments (that may be pigments except the listed white pigments) may be used as required.

Dispersing means in accordance with the method of producing the toner particles needs only to be used in the dispersion of the pigment in each of the toner particles. For example, a ball mill, a sand mill, an attritor, a roll mill, a jet mill, a homogenizer, a paint shaker, a kneader, an agitator, a Henschel mixer, a colloid mill, an ultrasonic homogenizer, a pearl mill, and a wet jet mill are each given as an apparatus that can be used as the dispersing means.

A dispersant can be added when the dispersion of the pigment is performed. Examples of the dispersant can include a hydroxy group-containing carboxylate, a salt of a long-chain polyaminoamide and a high-molecular weight acid ester, a salt of a high-molecular weight polycarboxylic acid, a high-molecular weight unsaturated acid ester, a high-molecular weight copolymerized product, a modified polyacrylate, an aliphatic polycarboxylic acid, a naphthalenesulfonic acid formalin condensate, a polyoxyethylene alkyl phosphate, and a pigment derivative. Commercial polymer dispersants, such as Solsperse series manufactured by Lubrizol, are also preferably used. In addition, synergists corresponding to various pigments can each be used as a dispersing aid. Any such dispersant and any such dispersing aid are preferably added in an amount of 1 part by mass or more and 50 parts by mass or less with respect to 100 parts by mass of the pigment.

In the present invention, the following material can be used in addition to the polymerizable polyolefin, the cationic polymerizable liquid monomer including the vinyl ether monomer, and the toner particles.

[Photopolymerization Initiator]

A compound represented by the following general formula (1) can be preferably used as a polymerization initiator for the cationic polymerizable compound that can be incorporated into the curable liquid developer of the present invention.

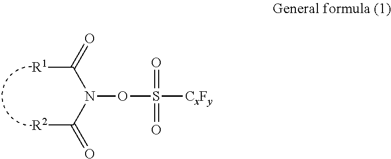

In the general formula (1), x represents an integer of 1 or more and 8 or less, y represents an integer of 3 or more and 17 or less, and R¹ and R² are bonded to each other to form a cyclic imide structure.

The use of the photopolymerization initiator represented by the general formula (1) provides a curable liquid developer having a high resistance unlike the case where an ionic photo-acid generator is used while enabling satisfactory fixation.

The photopolymerization initiator represented by the general formula (1) undergoes photodecomposition through UV irradiation to generate a sulfonic acid serving as a strong acid. In addition, when the initiator is used in combination with a sensitizer, the decomposition of the initiator and the generation of the sulfonic acid can be triggered by the absorption of UV light by the sensitizer.

Examples of the cyclic imide structure which R¹ and R² are bonded to each other to form can include a five-membered ring imide and a six-membered ring imide. In addition, a functional group containing R¹ and R² is a functional group for generating the sulfonic acid through UV irradiation. Therefore, a group that can absorb UV light is preferred.

In addition, even when the cyclic imide structure is a functional group that does not absorb the UV light, the use of a sensitizer to be described later can decompose the photopolymerization initiator represented by the general formula (1).

The cyclic imide structure may have an alkyl group, an alkyloxy group, an alkylthio group, an aryl group, an aryloxy group, an arylthio group, or the like as a substituent. Further, the cyclic imide structure may be condensed with any one of the other ring structures, such as an alicycle, a heterocycle, and an aromatic ring each of which may have a substituent.

CₓF_{y} represents a fluorocarbon group having a large electron-withdrawing property, and the group has 1 or more and 8 or less carbon atoms (x represents an integer of i or more and 8 or less), and has 3 or more and 17 or less fluorine atoms (y represents an integer of 3 or more and 17 or less).

When the number of carbon atoms is 1 or more, the synthesis of the strong acid becomes easy, and when the number is 8 or less, the initiator is excellent in storage stability. When the number of fluorine atoms is 3 or more, the initiator can act as a strong acid, and when the number is 17 or less, the synthesis of the photopolymerization initiator represented by the general formula (1) becomes easy.

Examples of CₓF_{y} in the general formula (1) include a linear alkyl group (RF1) in which a hydrogen atom is substituted by a fluorine atom, a branched alkyl group (RF2) in which a hydrogen atom is substituted by a fluorine atom, a cycloalkyl group (RF3) in which a hydrogen atom is substituted by a fluorine atom, and an aryl group (RF4) in which a hydrogen atom is substituted by a fluorine atom.

Examples of the linear alkyl group (RF1) in which a hydrogen atom is substituted by a fluorine atom include a trifluoromethyl group (x=1 and y=3), a pentafluoroethyl group (x=2 and y=5), a heptafluoro-n-propyl group (x=3 and y=7), a nonafluoro-n-butyl group (x=4 and y=9), a perfluoro-n-hexyl group (x=6 and y=13), and a perfluoro-n-octyl group (x=8 and y=17).

Examples of the branched alkyl group (RF2) in which a hydrogen atom is substituted by a fluorine atom include a perfluoroisopropyl group (x=3 and y=7), a perfluoro-tert-butyl group (x=4 and y=9), and a perfluoro-2-ethylhexyl group (x=8 and y=17).

Examples of the cycloalkyl group (RF3) in which a hydrogen atom is substituted by a fluorine atom include a perfluorocyclobutyl group (x=4 and y=7), a perfluorocyclopentyl group (x=5 and y=9), a perfluorocyclohexyl group (x=6 and y=11), and a perfluoro(i-cyclohexyl)methyl group (x=7 and y=13).

Examples of the aryl group (RF4) in which a hydrogen atom is substituted by a fluorine atom include a pentafluorophenyl group (x=6 and y=5) and a 3-trifluoromethyltetrafluorophenyl group (x=7 and y=7).

Of CₓF_{y}'s in the photopolymerization initiator each represented by the general formula (i), a linear alkyl group (RF1), a branched alkyl group (RF2), or an aryl group (RF4) is preferred, and a linear alkyl group (RF1) or an aryl group (RF4) is more preferred from the viewpoints of easy availability and the decomposability of a sulfonic acid ester moiety. The following group is particularly preferred: a trifluoromethyl group (x=1 and y=3), a pentafluoroethyl group (x=2 and y=5), a heptafluoro-n-propyl group (x=3 and y=7), a nonafluoro-n-butyl group (x=4 and y=9), or a pentafluorophenyl group (x=6 and y=5).

Specific examples [Exemplified Compounds B-1 to B-27] of the photopolymerization initiator that can be used in the present invention are given below, but the present invention is not limited to these examples.

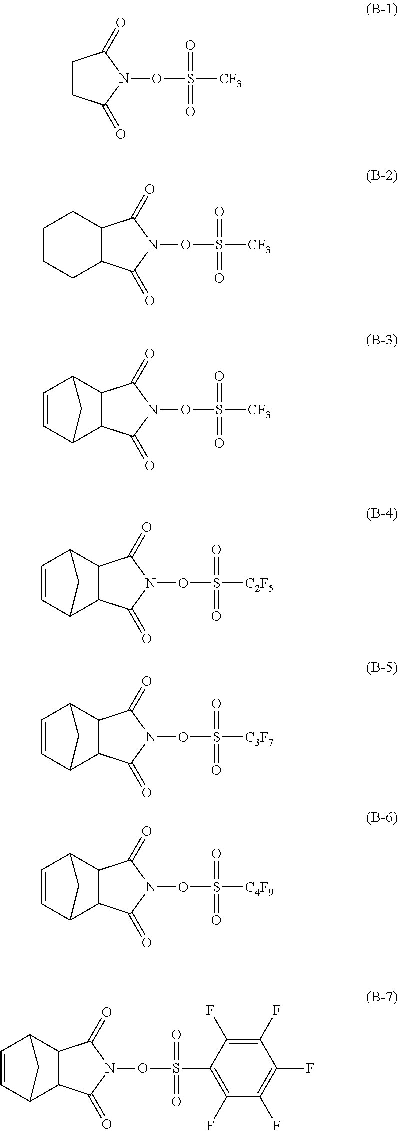

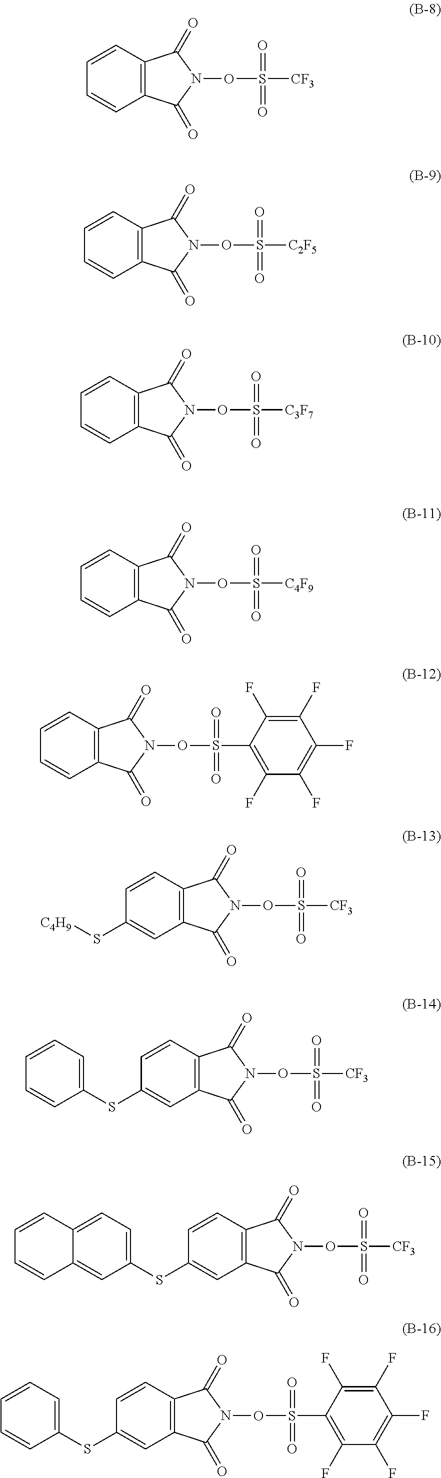

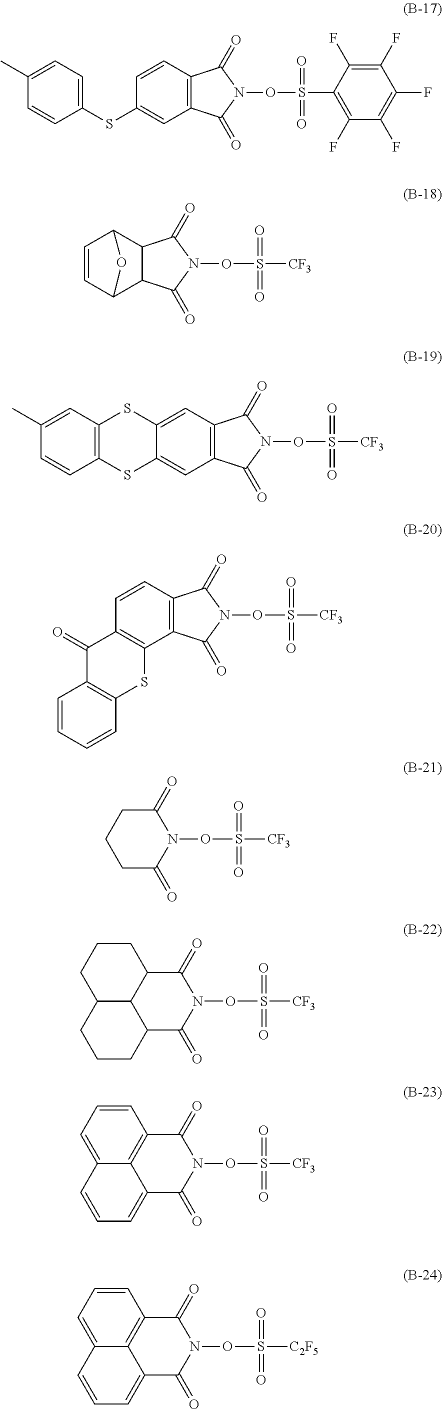

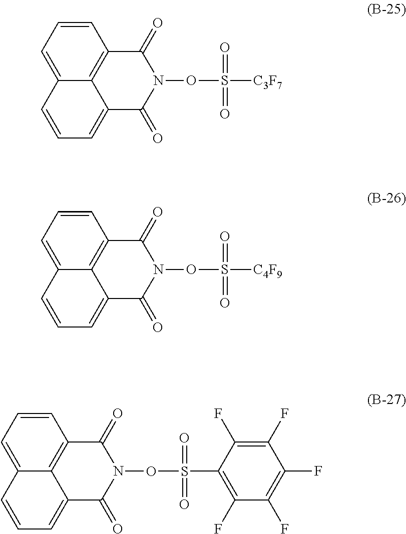

One kind of the photopolymerization initiators can be used, or two or more kinds thereof can be used in combination. The content of the photopolymerization initiator in the curable liquid developer of the present invention is preferably 0.01 part by mass or more and 5 parts by mass or less, more preferably 0.05 part by mass or more and 1 part by mass or less, still more preferably 0.1 part by mass or more and 0.5 part by mass or less with respect to 100 parts by mass of the cationic polymerizable liquid monomer mixed with the polymerizable polyolefin.

[Other Component]

The curable liquid developer of the present invention preferably contains any one of the following additives as required.

Sensitizer

A sensitizer may be added to the curable liquid developer of the present invention for the purpose of, for example, improving the efficiency with which the photopolymerization initiator generates the acid or lengthening the photosensitive wavelength of the initiator. Any sensitizer may be used as the sensitizer as long as the sensitizer sensitizes the photopolymerization initiator via an electron transfer mechanism or an energy transfer mechanism. Preferred examples thereof include: aromatic polycondensed ring compounds, such as anthracene, 9,10-dialkoxyanthracenes, pyrene, and perylene; aromatic ketone compounds, such as acetophenone, benzophenone, thioxanthone, and Michler's ketone; and heterocyclic compounds, such as phenothiazine and N-aryl oxazolidinones. The addition amount thereof is preferably 0.1 part by mass or more and 10 parts by mass or less, more preferably 1 part by mass or more and 5 parts by mass or less with respect to 1 part by mass of the photopolymerization initiator.

In addition, a sensitizing aid is preferably further added to the curable liquid developer of the present invention for the purpose of improving electron transfer efficiency or energy transfer efficiency between the sensitizer and the photopolymerization initiator. Specific examples of the sensitizing aid include: naphthalene compounds, such as 1,4-dihydroxynaphthalene, 1,4-dimethoxynaphthalene, 1,4-diethoxynaphthalene, 4-methoxy-1-naphthol, and 4-ethoxy-1-naphthol; and benzene compounds, such as 1,4-dihydroxybenzene, 1,4-dimethoxybenzene, 1,4-diethoxybenzene, 1-methoxy-4-phenol, and 1-ethoxy-4-phenol.

The addition amount of any such sensitizing aid is preferably 0.1 part by mass or more and 10 parts by mass or less, more preferably from 0.5 part by mass to 5 parts by mass with respect to 1 part by mass of the sensitizer.

Cationic Polymerization Inhibitor

A cationic polymerization inhibitor can also be added to the curable liquid developer of the present invention. Examples of the cationic polymerization inhibitor can include alkali metal compounds and/or alkaline earth metal compounds, and amines.

Preferred examples of the amines include alkanolamines, N,N-dimethylalkylamines, N,N-dimethylalkenylamines, and N,N-dimethylalkynylamines. Specific examples thereof include triethanolamine, triisopropanolamine, tributanolamine, N-ethyldiethanolamine, propanolamine, n-butylamine, sec-butylamine, 2-aminoethanol, 2-methylaminoethanol, 3-methylamino-1-propanol, 3-methylamino-1,2-propanediol, 2-ethylaminoethanol, 4-ethylamino-1-butanol, 4-(n-butylamino)-1-butanol, 2-(t-butylamino)ethanol, N,N-dimethylundecanol, N,N-dimethyldodecanolamine, N,N-dimethyltridecanolamine, N,N-dimethyltetradecanolamine, N,N-dimethylpentadecanolamine, N,N-dimethylnonadecylamine, N,N-dimethylicosylamine, N,N-dimethyleicosylamine, N,N-dimethylhenicosylamine, N,N-dimethyldocosylamine, N,N-dimethyltricosylamine, N,N-dimethyltetracosylamine, N,N-dimethylpentacosylamine, N,N-dimethylpentanolamine, N,N-dimethylhexanolamine, N,N-dimethylheptanolamine, N,N-dimethyloctanolamine, N,N-dimethylnonanolamine, N,N-dimethyldecanolamine, N,N-dimethylnonylamine, N,N-dimethyldecylamine, N,N-dimethylundecylamine, N,N-dimethyldodecylamine, N,N-dimethyltridecylamine, N,N-dimethyltetradecylamine, N,N-dimethylpentadecylamine, N,N-dimethylhexadecylamine, N,N-dimethylheptadecylamine, and N,N-dimethyloctadecylamine. In addition, for example, a quaternary ammonium salt can also be used. Of those, a secondary amine is particularly preferred as the cationic polymerization inhibitor.

The addition amount of the cationic polymerization inhibitor is preferably from 10 ppm to 5,000 ppm with reference to the mass of the curable liquid developer.

Radical Polymerization Inhibitor

A radical polymerization inhibitor may be added to the curable liquid developer of the present invention.

The photopolymerization initiator decomposes to an extremely slight extent during the storage of the curable liquid developer over time to turn into a radical compound, and polymerization is caused by the radical compound in some cases. The inhibitor is preferably added for suppressing the polymerization.

Examples of the radical polymerization inhibitor that can be applied include phenol-based hydroxy group-containing compounds, quinones, such as metoquinone (hydroquinone monomethyl ether), hydroquinone, and 4-methoxy-1-naphthol, hindered amine-based antioxidants, 1,1-diphenyl-2-picrylhydrazyl free radical, N-oxyl free radical compounds, nitrogen-containing heterocyclic mercapto-based compounds, thioether-based antioxidants, hindered phenol-based antioxidants, ascorbic acids, zinc sulfate, thiocyanic acid salts, thiourea derivatives, various sugars, phosphoric acid-based antioxidants, nitrous acid salts, sulfurous acid salts, thiosulfuric acid salts, hydroxylamine derivatives, aromatic amines, phenylenediamines, imines, sulfonamides, urea derivatives, oximes, polycondensates of dicyandiamide and polyalkylenepolyamines, sulfur-containing compounds, such as phenothiazine, tetraazaannulene (TAA)-based complexing agents, and hindered amines.

The addition amount of the radical polymerization inhibitor is preferably 1 ppm or more and 5,000 ppm or less with respect to the curable liquid developer.

Charge Director

A charge director may be incorporated into the curable liquid developer of the present invention as required. A known charge director can be utilized as the charge director. Specific examples of the compound include: oils and fats, such as linseed oil and soybean oil; alkyd resins; halogen polymers; aromatic polycarboxylic acids; acidic group-containing water-soluble dyes; oxidative condensates of aromatic polyamines; metal soaps, such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexanoate; sulfonic acid metal salts, such as a petroleum-based sulfonic acid metal salt and a metal salt of a sulfosuccinic acid ester; phospholipids, such as lecithin; salicylic acid metal salts, such as a t-butylsalicylic acid metal complex; and polyvinylpyrrolidone resins, polyamide resins, sulfonic acid-containing resins, and hydroxybenzoic acid derivatives.

Further, the curable liquid developer of the present invention may contain any other additive as required in addition to the charge director.

Other Additives

In addition to the above-described additives, for example, the following various known additives may be appropriately selected and used for the curable liquid developer of the present invention as required depending on the purpose of improvement of its performance, i.e., recording medium adaptability, storage stability, image stability, or the like: a surfactant, a lubricant, a filler, an antifoaming agent, a UV absorber, an antioxidant, a discoloration preventing agent, a fungicide, and a rust inhibitor.

[Physical Properties of Curable Liquid Developer]

The curable liquid developer of the present invention is preferably used after having been prepared so as to have the same physical property values as those of a related-art liquid developer. The volume resistivity of the curable liquid developer is preferably from 1×10¹⁰ Ω·cm to 1×10¹³ Ω·cm in order that the potential of an electrostatic latent image may not be dropped. In the present invention, a curable liquid developer satisfying the physical property values while obtaining high curability can be prepared.

[Electrophotographic Image Forming Apparatus]

The curable liquid developer of the present invention can be suitably used in a general electrophotographic image forming apparatus of an electrophotographic system. The developer is cured by, for example, a system based on UV light or a system based on an electron beam (EB).

When the curable liquid developer of the present invention is used in the UV curing system, after the transfer of an image onto a recording medium, the developer is quickly irradiated with the UV light to cure. Thus, the image is fixed.

For example, a mercury lamp, a metal halide lamp, an excimer laser, a UV laser, a cold-cathode tube, a hot-cathode tube, a black light, or a light emitting diode (LED) can be applied as a light source for the UV irradiation. Of those, a strip metal halide lamp, a cold-cathode tube, a hot-cathode tube, a mercury lamp or black light, or an LED is preferred.

The dose of the UV light is preferably from 0.1 mJ/cm² to 1,000 mJ/cm², and is more preferably from 0.1 mJ/cm to 500 mJ/cm² when the power saving of the electrophotographic image forming apparatus is considered.

### EXAMPLES

A method of producing the curable liquid developer of the present invention is described more specifically below by way of Examples. However, the present invention is not limited thereto, and any other example is permitted as long as the example does not deviate from the gist and application range thereof. In the following description, the terms “part(s)” and “%” mean “part(s) by mass” and “mass %”, respectively unless otherwise stated.

Typical synthesis examples of the polymerizable polyolefin having a vinyl ether group to be used in the present invention are described below.

### Synthesis Example 1

### (Synthesis of Exemplified Compound A-13)

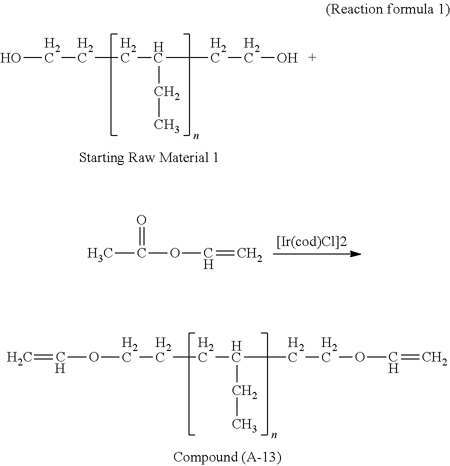

A hydrogenated polybutadiene having hydroxy groups at both of its terminals (1.5 g, 1 mmol) represented by Starting Raw Material 1 and vinyl acetate (6 mmol) were added to a mixed liquid of di-μ-chlorobis(1,5-cyclooctadiene)diiridium(I) [Ir(cod)Cl]₂ (6.7 mg, 0.01 mmol) and sodium carbonate (64 mg, 0.6 mmol) in toluene (1.0 ml), and the mixture was stirred under an argon atmosphere at 100° C. for 5 hours. The analysis of the reaction liquid by gas chromatography showed that the degree of conversion of Starting Raw Material 1 was 93% and a polyolefin having vinyl ether groups at both of its terminals (Compound A-13) represented by Compound A-13 was produced in 63% yield. An organic phase and an aqueous phase were separated from each other with a separating funnel, and the organic phase was subjected to column purification, concentrated under reduced pressure, and dried to provide Compound A-13 (weight-average molecular weight: 1,550). The resultant compound was a slightly brown and transparent viscous liquid. The FT-IR measurement of Compound A-13 confirmed that a peak derived from a hydroxy group disappeared.

### Synthesis Example 2

### (Synthesis of Exemplified Compound A-14)

Compound A-14 (weight-average molecular weight: 2,550) that was a slightly brown and transparent viscous liquid having vinyl ether groups at both of its terminals was synthesized by the same method as that of Synthesis Example 1 except that the following hydrogenated polyisoprene having hydroxy groups at both of its terminals (2.6 g, 1 mmol) was used as Starting Raw Material 2 instead of Starting Raw Material 1.

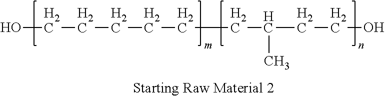

### Synthesis Example 3

### (Synthesis of Exemplified Compound A-12)

Compound A-12 (weight-average molecular weight: 2,450) that was a slightly brown solid having vinyl ether groups at both of its terminals was synthesized by the same method as that of Synthesis Example 1 except that the following hydrogenated polybutadiene (copolymer of 1,2-polybutadiene and 1,4-polybutadine) having hydroxy groups at both of its terminals (2.4 g, 1 mmol) was used as Starting Raw Material 3 instead of Starting Raw Material 1.

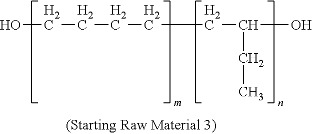

### Synthesis Example 4

### (Synthesis of Compound A-17)

Compound A-17 having vinyl ether groups at both of its terminals (weight-average molecular weight: 2,050) was synthesized by the same method as that of Synthesis Example 1 except that the following hydrogenated compound having hydroxy groups at both of its terminals (9.3 g, 1 mmol) obtained by using 1,4-polybutadiene as a raw material was used as Starting Raw Material 4 instead of Starting Raw Material 1.

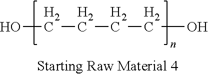

### Synthesis Example 5

### (Synthesis of Compound A-19)

Compound A-19 having vinyl ether groups at both of its terminals (weight-average molecular weight: 983.9) was synthesized by the same method as that of Synthesis Example 1 except that the following hydrogenated compound having hydroxy groups at both of its terminals (9.3 g, 1 mmol) obtained by using 1,4-polybutadiene as a raw material was used as Starting Raw Material 5 instead of Starting Raw Material 1.

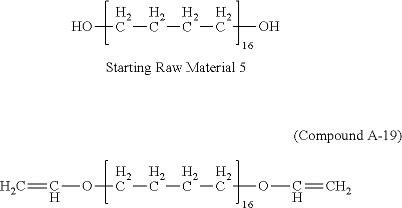

### Synthesis Example 6

### (Synthesis of High-Molecular Weight Form of Exemplified Compound A-12)

A high-molecular weight form of Compound A-12 (weight-average molecular weight: 10,200) that was a slightly brown solid having vinyl ether groups at both of its terminals was synthesized by the same method as that of Synthesis Example 1 except that a high-molecular weight form (m+n=180) of Starting Raw Material 3 (10.2 g, 1 mmol) was used instead of Starting Raw Material 1.

### Synthesis Example 7

### (Synthesis of Compound A-20)

Compound A-20 having a vinyl ether group (weight-average molecular weight: 942) was synthesized by the same method as that of Synthesis Example 1 except that the following hydrogenated compound having a hydroxy group at one terminal of 1,4-polybutadiene (4.6 g, 0.5 mmol) was used as Starting Raw Material 6 instead of Starting Raw Material 1.

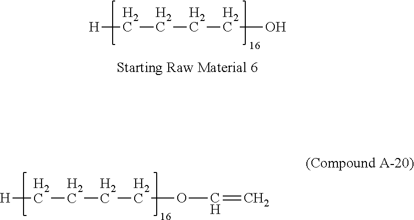

### Synthesis Example 8

### (Synthesis of Exemplified Compound A-21)

Compound A-21 having a vinyl ether group (weight-average molecular weight: 10,200) was synthesized by the same method as that of Synthesis Example 1 except that the hydrogenated compound having a hydroxy group at one terminal of a high-molecular weight form (m+n=180) of Starting Raw Material 7 (5.1 g, 0.5 mmol) was used as Starting Raw Material 7 instead of Starting Raw Material 1.

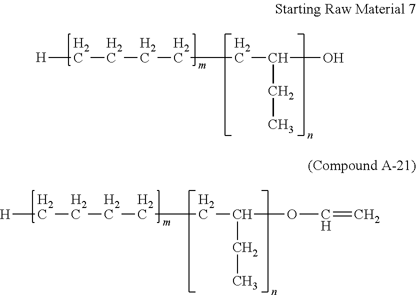

### Synthesis Example 9

### (Synthesis of Exemplified Compound A-22)

Compound A-22 having vinyl ether groups at both of its terminals (weight-average molecular weight: 872) was synthesized by the same method as that of Synthesis Example 1 except that the following hydrogenated compound having hydroxy groups at both of its terminals (8.2 g, 1 mmol) obtained by using 1,4-polybutadiene as a raw material was used as Starting Raw Material 8 instead of Starting Raw Material 1.

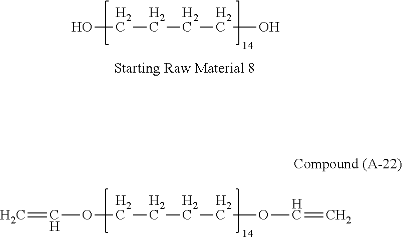

### Synthesis Example 10

### (Synthesis of Exemplified Compound A-23)

Compound A-23 having vinyl ether groups at both of its terminals (weight-average molecular weight: 829) was synthesized by the same method as that of Synthesis Example 1 except that the following hydrogenated compound having a hydroxy group at one of its terminals (4.0 g, 0.5 mmol) obtained by using 1,4-polybutadiene as a raw material was used as Starting Raw Material 9 instead of Starting Raw Material 1.

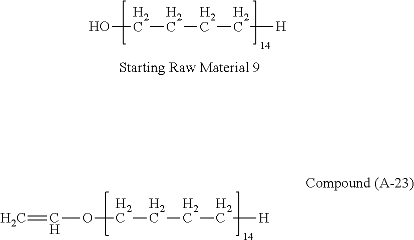

### Example 1

### (Production of Toner Particles)

25 Parts of NUCREL N1525 (ethylene-methacrylic acid resin/manufactured by Du Pont-Mitsui Polychemicals) and 75 parts of dodecyl vinyl ether were loaded into a separable flask, and the temperature of the mixture was increased to 130° C. over 1 hour in an oil bath while the mixture was stirred with a three-one motor at a rotational speed of 200 rpm. After having been held at 130° C. for 1 hour, the mixture was slowly cooled at a rate of 15° C. per 1 hour to produce a toner particle precursor. The resultant toner particle precursor was of a white paste form.

59.40 Parts of the toner particle precursor, 4.95 parts of Pigment Blue 15:3 serving as a pigment, 0.2 part of aluminum tristearate serving as a charge adjuvant, and 35.45 parts of dodecyl vinyl ether were filled into a planetary bead mill (CLASSIC LINE P-6/Fritsch) together with zirconia beads each having a diameter of 0.5 mm, and the mixture was pulverized at room temperature and 200 rpm for 4 hours to provide a toner particle dispersion (solid content: 20 mass %) The volume-average particle diameter of toner particles in the resultant toner particle dispersion measured with NANOTRAC 150 (manufactured by Nikkiso Co., Ltd.) was 0.85 μm.

(Preparation of Curable Liquid Developer)

0.1 Part of hydrogenated lecithin (LECINOL S-10/manufactured by Nikko Chemicals Co., Ltd.) serving as a charge director, 78.7 parts of cyclohexanediethanol divinyl ether (Exemplified Compound C-17, SP value: 8.81 (cal/cm³)^{1/2}) serving as a cationic polymerizable liquid monomer, 10.0 parts of Exemplified Compound A-13 synthesized in Synthesis Example 1 serving as a polymerizable polyolefin, 0.2 part of Exemplified Compound B-26 serving as a photopolymerization initiator, 0.5 part of 2,4-diethylthioxanthone (manufactured by Nippon Kayaku Co., Ltd.) serving as a sensitizer, and 0.5 part of 1,4-diethoxynaphthalene serving as a sensitizing aid were added to 10.0 parts of the toner particle dispersion. Thus, a curable liquid developer was obtained.

Evaluation

(Fixability) The curable liquid developer was dropped onto a polyethylene terephthalate film under each of an environment at room temperature, i.e., 25° C. and a humidity of 50% as a fixability test 1, and an environment at room temperature, i.e., 25° C. and a humidity of 30% as a fixability test 2, and bar coating was performed with a wire bar (No. 6). After that, the developer was irradiated with light having a wavelength of 365 nm by using a high-pressure mercury lamp having a lamp output of 120 mW/cm² to form a cured film. The dose of the light when the developer completely cured without any tackiness on its surface was measured and ranked as described below.
Rank 10: 100 mJ/cm²
Rank 9: 150 mJ/cm²
Rank 8: 200 mJ/cm²
Rank 7: 300 mJ/cm²
Rank 6: 400 mJ/cm²
Rank 5: 800 mJ/cm²
Rank 4: 1,000 mJ/cm²
Rank 3: 1,500 mJ/cm²
Rank 2: 2,000 mJ/cm²
Rank 1: not cured

(Developability)

An electrostatic pattern was formed on electrostatic recording paper at a surface charge of 500 V, and was developed with the curable liquid developer and a roller developing machine. Whether or not the resultant image was satisfactory was visually observed.

Rank 5: A high-density and high-definition image was obtained.
Rank 4: Slight density unevenness was present, or slight image blurring was observed.
Rank 3: Density unevenness or image blurring was observed here and there, or was remarkable, but the pattern was found to be developed in a generally satisfactory manner.
Rank 2: Severe density unevenness or severe image blurring occurred, and hence the development was insufficient.
Rank 1: The pattern could not be developed.

(Film Uniformity)

Rank 5: A completely flat and uniform film was obtained.
Rank 3: A generally flat and uniform film was obtained, though the irregularities of a film were slightly observed or the whitening thereof was observed in a small portion thereof.
Rank 1: The irregularities of a film were, or the whitening thereof was, observed everywhere.

### Examples 2 to 14 and Comparative Examples 1 to 4

Curable liquid developers were each obtained in the same manner as in Example 1 except that the polymerizable polyolefin, the vinyl ether monomer, and the photopolymerization initiator in the curable liquid developer obtained in Example 1 were blended so as to have composition shown in Table 1. In Example 10, CPI-210S (manufactured by San-Apro Ltd.; triarylsulfonium salt-based polymerization initiator, B-28) was used as a polymerization initiator, and its addition amount was set to 1 part. In Comparative Example 1, no polymerizable polyolefin was added and the amount of the vinyl ether monomer (Exemplified Compound C-17) was set to 88.7 parts. In Comparative Examples 2 to 4, the starting raw materials used in Synthesis Examples 1 to 3, i.e., compounds each free of any vinyl ether group were added.

The same evaluations as those of Example 1 were performed by using the curable liquid developers thus obtained. The results of the evaluations are shown in Table 1.

TABLE 1

| | Construction of curable liquid developer | | | | | | | |
|---|---|---|---|---|---|---|---|---|
| | Polymerizable | Average | Vinyl ether | | Evaluation | | | |
| | Polyolefine | molecular | monomer | | Fixability | Fixability | | Film |
| | (SP value) | weight | (SP value) | Initiator | test 1 | test 2 | Developability | uniformity |
| Example 1 | Compound A-13 (8.16) | 1,550 | C-17 (8.81) | B-26 | 10 | 10 | 5 | 5 |
| Example 2 | Compound A-13 (8.16) | 1,550 | C-24 (8.09) | B-26 | 10 | 10 | 5 | 5 |
| Example 3 | Compound A-14 (8.49) | 2,550 | C-17 (8.81) | B-26 | 10 | 10 | 5 | 5 |
| Example 4 | Compound A-14 (8.49) | 2,550 | C-25 (8.08) | B-26 | 10 | 10 | 5 | 5 |
| Example 5 | Compound A-12 (8.42) | 2,450 | C-17 (8.81) | B-18 | 9 | 10 | 4 | 5 |
| Example 6 | Compound A-17 (8.56) | 2,050 | C-17 (8.81) | B-18 | 8 | 10 | 4 | 5 |
| Example 7 | Compound A-17 (8.56) | 2,050 | C-10 (10.30) | B-18 | 7 | 10 | 4 | 3 |
| Example 8 | Compound A-17 (8.56) | 2,050 | C-17 (8.81) | B-28 | 7 | 9 | 3 | 3 |
| Example 9 | Compound A-19 (8.51) | 980 | C-17 (8.81) | B-28 | 7 | 8 | 3 | 3 |
| Example 10 | Compound A-12 (8.42) | 10,200 | C-17 (8.81) | B-28 | 8 | 9 | 3 | 3 |
| Example 11 | Compound A-20 (8.47) | 940 | C-17 (8.81) | B-28 | 6 | 8 | 3 | 3 |
| Example 12 | Compound A-21 (8.24) | 10,200 | C-17 (8.81) | B-28 | 7 | 8 | 3 | 3 |
| Example 13 | Compound A-22 (8.51) | 870 | C-17 (8.81) | B-28 | 6 | 7 | 3 | 3 |
| Example 14 | Compound A-23 (8.45) | 830 | C-17 (8.81) | B-28 | 6 | 6 | 3 | 3 |
| Comparative | No addition | — | C-17 (8.81) | B-28 | 4 | 4 | 3 | 3 |
| Example 1 | | | | | | | | |
| Comparative | Starting Raw Material | 1,500 | C-17 (8.81) | B-18 | 2 | 2 | 3 | 1 |
| Example 2 | 1 (8.63) | | | | | | | |
| Comparative | Starting Raw Material | 2,500 | C-17 (8.81) | B-18 | 2 | 2 | 3 | 1 |
| Example 3 | 2 (8.81) | | | | | | | |
| Comparative | Starling Raw Material | 2,400 | C-17 (8.81) | B-18 | 2 | 2 | 3 | 1 |
| Example 4 | 3 (8.63) | | | | | | | |

A developer satisfying all of the following conditions in the results of Table 1 was regarded as passing: the ranks of both the fixability test 1 and the fixability test 2 were 6 or higher, and the ranks of both the developability and the film uniformity were 3 or higher. It is found that irradiation energy needed for fixation in the fixability test 1 tends to be larger than that in the fixability test 2, and hence it becomes harder for the vinyl ether compound to cure as the humidity rises. It is found that the fixability was improved in each of Examples where the polymerizable polyolefins were added while sufficient fixability was not obtained in Comparative Example 1 where no polymerizable polyolefin was added. This is probably because of the following reason: when the curable liquid developer was applied onto the polyethylene terephthalate film, the polymerizable polyolefin component having a high molecular weight and a high viscosity suppressed the migration of a water molecule in the film to the inside of the thin film of the curable liquid developer. It is found that when Starting Raw Materials 1 to 3 each free of a vinyl ether group serving as a polymerizable functional group are each added in a large amount like any one of Comparative Examples 2 to 4, the polymerization itself of the vinyl ether monomer is inhibited and hence it becomes hard for the developer to cure.

When attention is paid to the number of vinyl ether functional groups of a polymerizable polyolefin, it is found that in Example 9 and Example 11 having the same main chain and different numbers of vinyl ether functional groups, the fixability of Example 9 having the larger number of functional groups is more satisfactory than that of the other.

When attention is paid to the molecular weight of a polymerizable polyolefin, it is found that in Example 8, Example 9, and Example 13, the polymerizable polyolefins each having two vinyl ether groups and having different main chain lengths are used, but the weight-average molecular weight of the polymerizable polyolefin in Example 8 is 1,000 or more, the weight-average molecular weight in Example 9 is 1,000 or less, and the weight-average molecular weight in Example 13 is 900 or less, and the results of the fixability tests become more satisfactory as the weight-average molecular weight increases.

In addition, in Example 7, the vinyl ether monomer having a SP value higher than that of Example 6 was used as a vinyl ether monomer, and as a result, the fixability in the fixability test 1 slightly deteriorated. This is assumed to be because it became easy for the curable liquid developer to take in moisture. Further, in Example 7, an influence on the film uniformity started to appear. This is assumed to be because a difference in SP value between the polymerizable polyolefin and the vinyl ether monomer enlarged, and hence compatibility between the two compounds slightly reduced.

### Examples 15 to 18 and Comparative Examples 5 to 7

### (Preparation of Curable Liquid)

87.0 Parts of 1,4-butanediol divinyl ether (Exemplified Compound C-19, SP value: 8.18 (cal/cm³)^{1/2}) serving as a vinyl ether monomer, 1 part of CPI-210S (manufactured by San-Apro Ltd.) serving as a photopolymerization initiator, 1.0 part of 2,4-diethylthioxanthone (manufactured by Nippon Kayaku Co., Ltd.) serving as a sensitizer, 1.0 part of 1,4-diethoxynaphthalene, and 10 parts by weight of a polymerizable polyolefin were added to produce a curable liquid free of any toner particle. The used polymerizable polyolefin is as shown in Table 2. In Comparative Example 5, no polymerizable polyolefin was added and the amount of 1,4-butanediol divinyl ether was set to 97.0 parts.

Evaluations for the fixability test 1 and the film uniformity were performed by the same test methods as those of Example 1. The results are as shown in Table 2.

TABLE 2

| | | | Evaluation | |
|---|---|---|---|---|
| | Polymerizable | Average | | Film |
| | poylyolefin | molecular | Fixability | uni- |
| | (SP value) | weight | test 1 | formity |
| Example 15 | Compound A-13 (8.16) | 1,550 | 8 | 5 |
| Example 16 | Compound A-14 (8.49) | 2,550 | 8 | 5 |
| Example 17 | Compound A-12 (8.42) | 2,450 | 7 | 5 |
| Example 18 | Compound A-3 (8.22) | 2,000 | 6 | 3 |
| Comparative | No addition | — | 4 | 3 |
| Example 5 | | | | |
| Comparative | Starting Raw Material | 1,500 | 2 | 1 |
| Example 6 | 1 (8.63) | | | |
| Comparative | Starting Raw Material | 2,400 | 2 | 1 |
| Example 7 | 3 (8.63) | | | |

As can be seen from the results of Table 2, Examples 15 to 18 where the polymerizable polyolefins were added improved in fixability as compared to Comparative Example 5 where no polymerizable polyolefin was added. In addition, it became hard for each of Comparative Examples 6 and 7 to fix because Starting Raw Material 1 or 3 free of any vinyl ether group was added.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-089515, filed Apr. 24, 2015, and Japanese Patent Application No. 2016-080502, filed Apr. 13, 2016, which are hereby incorporated by reference herein in their entirety.

1. A curable liquid developer, comprising:
a cationic polymerizable liquid monomer including a vinyl ether monomer; and
toner particles insoluble in the cationic polymerizable liquid monomer, wherein
the curable liquid developer further comprises a polymerizable polyolefin comprising a polyolefin in a main chain thereof, at least one terminal of the polyolefin having a vinyl ether group.

2. A curable liquid developer according to claim 1, wherein the polymerizable polyolefin has vinyl ether groups at a plurality of terminals of the polyolefin.

3. A curable liquid developer according to claim 1, wherein the polymerizable polyolefin has a weight-average molecular weight of 900 to 10,000.

4. A curable liquid developer according to claim 3, wherein the polymerizable polyolefin has a weight-average molecular weight of 1,000 to 10,000.

5. A curable liquid developer according to claim 1, wherein the polymerizable polyolefin has a structure derived from one of 1,2-polybutadiene and 1,4-polyisoprene, and has hydrogen added to a double bond moiety except the vinyl ether group.

6-7. (canceled)

8. A curable liquid developer according to claim 2, wherein the polymerizable polyolefin has a weight-average molecular weight of 900 to 10,000.

9. A curable liquid developer according to claim 2, wherein the polymerizable polyolefin has a weight-average molecular weight of 1,000 to 10,000.

10. A curable liquid developer according to claim 2, wherein the polymerizable polyolefin has a structure derived from one of 1,2-polybutadiene and 1,4-polyisoprene, and has hydrogen added to a double bond moiety except the vinyl ether group.

11. A curable liquid developer according to claim 3, wherein the polymerizable polyolefin has a structure derived from one of 1,2-polybutadiene and 1,4-polyisoprene, and has hydrogen added to a double bond moiety except the vinyl ether group.

12. A curable liquid developer according to claim 4, wherein the polymerizable polyolefin has a structure derived from one of 1,2-polybutadiene and 1,4-polyisoprene, and has hydrogen added to a double bond moiety except the vinyl ether group.

13. A curable liquid developer according to claim 8, wherein the polymerizable polyolefin has a structure derived from one of 1,2-polybutadiene and 1,4-polyisoprene, and has hydrogen added to a double bond moiety except the vinyl ether group.

14. A curable liquid developer according to claim 9, wherein the polymerizable polyolefin has a structure derived from one of 1,2-polybutadiene and 1,4-polyisoprene, and has hydrogen added to a double bond moiety except the vinyl ether group.
